(19) United States
(12) Patent Application Publication
(10) Pub. No.: US 2025/0027569 A1
(43) Pub. Date: Jan. 23, 2025

(54) VALVE

(71) Applicant: VAT Holding AG, Haag (CH)

(72) Inventor: Michael DÜR, Hohenweiler (AT)

(73) Assignee: VAT Holding AG, Haag (CH)

(21) Appl. No.: 18/569,300

(22) PCT Filed: Jun. 22, 2022
(86) PCT No.: PCT/EP2022/067012

§ 371 Date: Dec. 12, 2023

(30) Foreign Application Priority Data
Jul. 12, 2021 (DE) 102021117955.6

(51) Int. Cl. F16K 3/314; F16K 3/02; F16K 51/02

(52) U.S. Cl. CPC F16K 3/314; F16K 3/0218; F16K 51/02

(57) ABSTRACT

A valve (1), in particular a vacuum valve, with a valve housing (2) and a closing member (3) for closing a valve opening (4), and with a valve drive (5) for moving the closing member (3) to and fro between a closed position, in which the closing member (3) closes the valve opening (4), and an open position, in which the closing member (3) fully or partially opens the valve opening (4), wherein the closing member (3) is connected to the valve drive (5) by means of a valve rod (6) of the valve (1), and the closing member (3) is removably fastened or fastenable to the valve rod (6) by means of a releasable connecting device (7), wherein the releasable connecting device (7) has a fastening magnet (8) for removably fastening the closing member (3) to the valve rod (6) by means of magnetic attraction forces.

### CROSS-REFERENCE TO RELATED APPLICATIONS

This application is a 371 National Phase of PCT/EP2022/067012, filed Jun. 22, 2022, which claims priority to German Patent Application No. 10 2021 117 955.6, filed Jul. 12, 2021, both of which are incorporated herein by reference as if fully set forth.

### TECHNICAL FIELD

The present invention concerns a valve, in particular a vacuum valve, with a valve housing and a closing member for closing a valve opening, and with a valve drive for moving the closing member to and fro between a closed position, in which the closing member closes the valve opening, and an open position, in which the closing member fully or partially opens the valve opening, wherein the closing member is connected to the valve drive by means of a valve rod of the valve, and the closing member is removably fastened or fastenable to the valve rod by means of a releasable connecting device.

### BACKGROUND

Valves of this type are known in a multiplicity of embodiments and are used in particular in vacuum technology. In order to be able to service, clean and/or replace the closing members from time, it is known to fasten these removably to the valve rod by means of releasable connecting devices. A common type of connecting device in the prior art is a screw connection as shown for example in DE 10 2008 061 315 A1. In particular when such valves are used in vacuum technology, it is fundamental to avoid the generation of particles. Screw connections are critical in this connection since particles can be generated when screwing together or when unscrewing.

### SUMMARY

The object of the invention is to equip a valve of the type cited initially with a releasable connecting device in which the generation of particles on release and refastening of the closing member from and to the valve rod can be better avoided.

To achieve this object, the invention proposes a valve having one or more of the features disclosed herein.

Thus, according to the invention, it is provided that the releasable connecting device comprises a fastening magnet for removably fastening the closing member to the valve rod by means of magnetic attraction forces.

In contrast to the screw connections commonly used in the prior art for releasably fastening the closing member to the valve rod, the invention thus provides a magnetic fastening of the closing member to the valve rod by means of magnetic attraction forces. The latter are provided by the fastening magnet of the connecting device. Screw connections, and the associated generation of particles on release and reconnection of the connection device, may thus be avoided according to the invention. Also, the invention provides a very simple type of connecting device which allows fastening of the closing member to the valve rod as easily as removal of the closing member from the valve rod. The fastening magnet may be arranged on the valve rod but equally well also on the closing member. The fastening magnet may cooperate with a magnetizable material on the respective other component. It may however also be provided that a fastening magnet is arranged on both the valve rod and on the closing member. In this case, particularly high magnetic attraction forces are provided for removable fastening of the closing member to the valve rod. The fastening element may be a permanent magnet but also an electromagnet.

In principle, it is pointed out that the releasable connecting device according to the invention may have either one or also several fastening magnets. In general, the terms “a” and “one” used in the claims and in the description should be understood in the sense of “at least one”, unless the context indicates otherwise.

The closing member may be removably fastened or fastenable directly on the valve rod by means of the releasable connecting device according to the invention. It may however also be provided that an attachment, such as e.g. the crossmember indicated in DE 10 2008 061 315 A1, is arranged on the closing member. In such cases, the releasable connecting device according to the invention may then serve to removably fasten the valve rod to the attachment, whereby then also the closing member is removably fastened or fastenable-albeit indirectly-on the valve rod by means of the releasable connecting device according to the invention.

To release the closing member from the valve rod, it may be sufficient to pull on the closing member with correspondingly great force so that the attraction forces provided by the fastening magnet are overcome. In order however to keep the force required to remove the closing member from the valve rod as low as possible, particularly preferred variants of the invention provide that the valve has a mechanically or electrically driven release device for releasing the connection between the closing member and the valve rod. This release device of the valve may be arranged or formed both on the closing member and also on the valve rod. It facilitates removal of the closing member from the valve rod in that it weakens or eliminates the magnetic attraction forces generated by the fastening magnet, in order to allow removal of the closing member from the valve rod with as little force as possible. To achieve this, for example the fastening magnet may be configured as an electromagnet which can be switched on and off. Another possibility for achieving this is for the release device to have a counter-magnet for weakening or eliminating the magnetic attraction forces of the fastening magnet. Favorably, it is provided that the release device has at least two operating states, wherein in a first operating state it does not counter or only slightly counters the magnetic attraction forces of the fastening magnet, and in a second operating state it counters the magnetic attraction forces of the fastening magnet at least more strongly than in the first operating state, and preferably eliminates these completely. The counter-magnet of the release device may be arranged on the valve rod and/or on the closing member. It is also conceivable that the counter-magnet is arranged on a separate extraction tool of the valve, which is only used when the closing member is to be removed from the valve rod or replaced thereon. The counter-magnet may be both a permanent magnet or also an electromagnet.

The invention may be used in widely varying types of valves known in the prior art, in order to removably fasten the closing member to the valve rod. Usually, on its path from the closed position to the open position, the closing member assumes various intermediate positions. The open position specified in the claims could also be described as the maximally open position. It is the position of the closing member in which the valve opening is maximally opened by the closing member. The open position or maximally open position may be a position in which the closing member completely opens the valve opening. The open position or maximally open position may however also be a position in which the closing member still partly covers the valve opening.

Valves configured according to the invention may also be corner valves, shuttle valves or similar. Particularly preferably, the valve according to the invention is an L-shaped valve. In an L-shaped valve, during the opening process, the closing member is initially moved in a first movement portion from the closed position into an intermediate position. In this intermediate position, the closing member is still congruent with the valve opening to be closed, but no longer closes this. In a second movement portion, the closing member is then brought out of the intermediate position into the open position, in which the closing member fully or partially opens the valve opening. Said movement tracks are arranged at an angle to one another. The closing process takes place in the reverse direction or order. Such L-shaped valves are known in themselves in the prior art in numerous embodiments. In the prior art, there are solutions which have a single valve drive. There are however also variants of L-shaped valves which have a separate valve drive for each movement track portion. All these valve drives known in themselves may be used in valves according to the invention. The valve drives may be electric, pneumatic, hydraulic or other valve drives.

The valve opening is usually an opening in the valve housing. In this case, the valve opening is arranged in the valve housing. However, embodiments of valves according to the invention are conceivable in which the valve opening, which is closable by means of the closing member, is not formed directly on the valve housing. It may e.g. also be an opening into a process chamber or similar.

In order to facilitate the removal of the closing member from the valve rod, and also the fastening of the closing member to the valve rod, it is favorably provided that the closing member has an adapter for manual removal of the closing member from the valve rod and/or for manual fastening of the closing member to the valve rod. Such an adapter may be configured for example such that it can be gripped directly by the hand. The adapter may however also be specially designed for receiving a manually guided extraction tool for removing the closing member from the valve rod or fastening it thereto. For fastening the extraction tool on or in the adapter of the closing member, various connection types already known from the prior art may be used, such as e.g. screw connections, clamp connections, snap-fit connections, bayonet closures, magnetic or electrostatic connections, or similar.

So that the closing member can be removed from the valve housing for service, cleaning or repair purposes, it is favorably provided that, on a side of the closing member facing away from the valve rod, the valve housing has a closable housing opening for extraction of the closing member from the valve housing. The valve housing may have e.g. a removable housing cover, a flap, door or similar in the region of the housing opening.

So that the closing element is always automatically correctly oriented when fastened or refastened to the valve rod, preferred embodiments of the invention provide that, for orienting the closing member on the valve rod, respective form-fit elements are formed on the valve rod and on the closing member. Because of their shaping, the form-fit elements thus cooperate with one another during fastening of the closing member on the valve rod such that the closing member can only be fastened to the valve rod in the correct position and orientation. Thus, it can be ensured that in the closed position, after fastening to the valve rod, the closing member optimally closes the valve opening with the desired compressive strength. The mutually cooperating form-fit elements on the valve rod and closing member must be matched to one another in their shape in order to achieve said effect. In principle however, irrespective thereof, they may have very different forms. The form-fit elements may be polygonal, in particular square, or take the form of a tongue and groove, or be configured in other suitable ways as long as their shaping achieves the corresponding orientation effect.

The closing member of the valve according to the invention may in principle be configured in very different ways. It may also be a closing needle or similar. Particularly preferably, the closing member is flat. In other words, the closing member is preferably a valve disc. Correspondingly large valve openings can be closed with such valve discs. The valve opening may e.g. have an opening cross-sectional area of at least 6000 mm2 or at least 12000 mm2. The closing members or valve discs are then formed correspondingly large so that they are suitable for closing correspondingly large valve openings.

As already stated initially, the valve according to the invention is suitably a vacuum valve, i.e. a valve which may be used in vacuum technology. Usually, vacuum technology comprises operating states with pressures of less than or equal to 0.001 mbar (millibar) or 0.1 Pascal. Vacuum valves are valves which are designed for these pressure ranges and/or corresponding pressure differences relative to the environment. However, the term “vacuum valve” is also generally used for valves designed for pressures below normal pressure, i.e. less than 1 bar.

### BRIEF DESCRIPTION OF THE DRAWINGS

Further features and details of preferred embodiments of the invention are explained below as examples in the description of the figures with reference to various embodiment variants of the invention. In the drawings:

FIGS. 1 to 8 show a first variant of a valve according to the invention;

FIG. 9 shows a first alternative embodiment of the connecting device according to the invention;

FIGS. 10 to 13 show a second alternative embodiment of a connecting device for a valve according to the invention, and

FIGS. 14 to 16 show a further variant of a possible configuration of a connecting device of a valve according to the invention.

### DETAILED DESCRIPTION

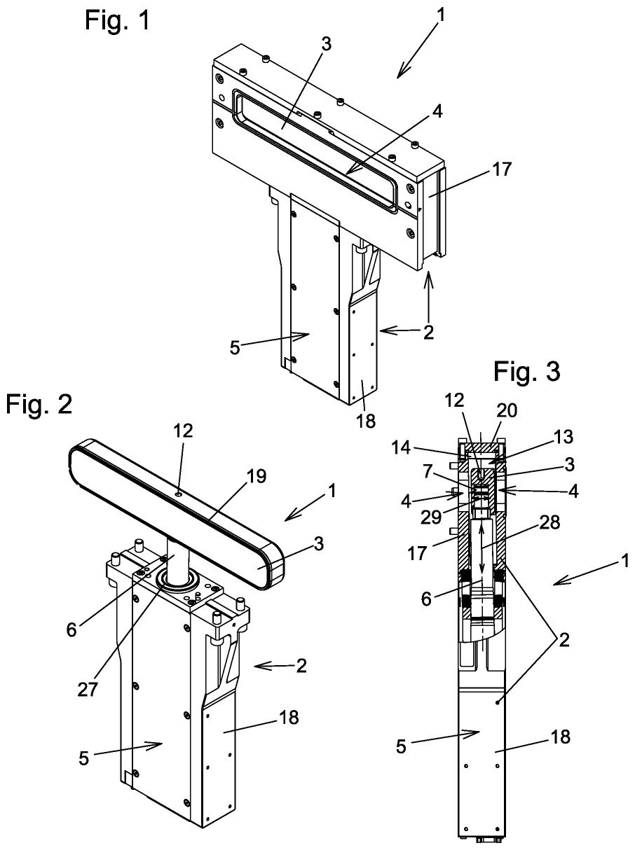

The first exemplary embodiment of the invention is now explained below with reference to FIGS. 1 to 8. However, FIGS. 1 to 7 show features of the valve 1 according to the invention, which may also be used in the other variants according to the invention explained below.

FIG. 1 shows a perspective external view of the valve 1 according to the invention with the valve housing 2, which in this exemplary embodiment is designed in two pieces so that it has a first housing part 17 and a second housing part 18. The two housing parts 17 and 18 can be connected together in a suitable fashion known in itself, e.g. by screwing. The second housing part 18 contains the valve drive 5, not shown here in more detail, which may be configured in any fashion known from the prior art. This has already been explained above.

The second housing part 17, and hence also the valve housing 2 in this exemplary embodiment, contains the valve opening 4, which can be closed by means of the closing member 3 in the closed position. In the variant shown here, the closing member 3 is arranged in the first housing part 17. It can be moved to and fro by means of the valve drive 5 in a known manner known between a closed position, in which the closing member 3 closes the valve opening 4, and an open position in which the closing member 3 fully or partially opens the valve opening 4.

Naturally, it may also be a one-piece valve housing 2. The valve opening 4 could equally well—as already explained above—be formed not in the valve housing 2 but in another housing. This too is known in the prior art.

The closing member 3 is connected to the valve drive 5 by means of the valve rod 6. The connection between the closing member 3 and the valve 6 takes place via a releasable connecting device 7 according to the invention, which is explained below in various variants.

The fastening of the valve 1 with its valve housing 2 on corresponding process chambers, lines or similar is known in itself and need not be explained further here. The mounting of the valve 1 on the corresponding process chamber or line is such that the valve opening 4, closable by means of the closing member 3, aligns with a corresponding opening of the process chamber or line.

FIG. 2 shows the valve 1 from FIG. 1 without the first housing part 17. Here it can clearly be seen that in this embodiment, the closing member 3 is formed as a valve disc. A peripheral seal 19 is attached thereto and seals the closing member 3, in the closed position, against the valve seat formed on the first housing part 17 or on the valve housing 2. This too, like alternative embodiments thereof, is known in itself and need not be explained further. FIG. 2 also clearly shows that in this exemplary embodiment, the valve rod 6—as known in itself-passes through a vacuum passage 27 between the second housing part 18 and the first housing part 17. This seals the valve rod 6 against the two housing parts 17 and 18, and hence also seals the two housing parts 17 and 18 against one another. This is also known in itself, but is not essential to the invention here. The fastening of the valve rod 6 to the valve drive 5 is not shown here but may also be configured as in the prior art. The valve 1 shown here is a so-called L-shaped valve as explained initially. The double arrow 28 illustrates the movement track on which the closing member 3, fastened to the valve rod 6, is moved to and fro by means of the valve drive 5 between the open position, in which the valve opening 4 is fully or partially opened, and the intermediate position shown in FIG. 3. In the intermediate position shown in FIG. 3, the closing member 3 already aligns with the valve opening 4 but is not yet pressed tightly against this. Between the closed position, in which the closing member 3 closes the valve opening 4, and the intermediate position shown in FIG. 3, the closing member is moved by the valve drive 5 to and fro on the movement track illustrated by the double arrow 29. The two movement tracks are oriented at an angle to one another, often at an orthogonal angle. However, other relative orientations of the two movement tracks are also possible. This is also known in the prior art. During the opening process, the closing member 3 is however moved from the closed position, along the movement track illustrated by the double arrow 29, initially into the intermediate position according to FIG. 3, and from there along the movement track illustrated by the double arrow 28 into the open position. During the closing process, the movement takes place in the reverse direction.

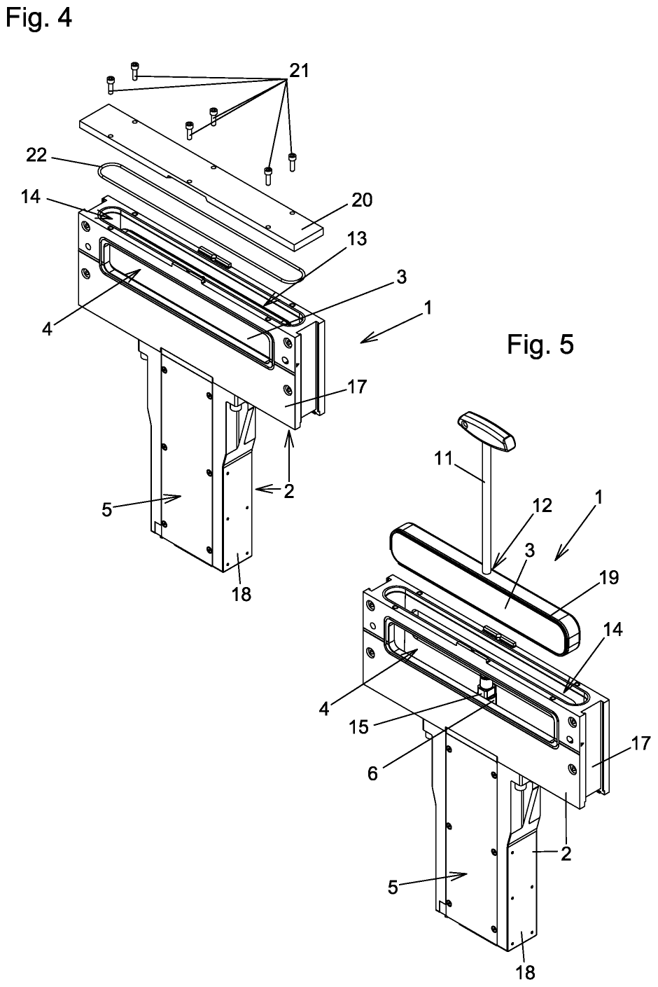

FIG. 4 shows as an example that preferred variants provide that on the side 13 of the closing member 3 facing away from the valve rod 6, the valve housing 2 has a closable housing opening 14 for extraction of the closing member 3 from the valve housing 2. In the exemplary embodiment shown, the housing opening 14 can be closed by means of the housing cover 20 and the screws 21. The necessary tightness is provided by the seal 22. Naturally, the housing opening 14 could however also be closable by a corresponding door, flap or similar. The housing opening 14 however allows, in a simple fashion, the closing member 3 to be extracted from the valve housing 2 for cleaning, servicing or replacement purposes, or introduced therein accordingly in order to fasten the closing member 3 to the valve rod 6. In FIG. 5, the housing cover 20 has been detached and the closing member 3 removed from the valve rod 6. To remove the closing member 3 from the valve rod 6, an extraction tool 11 is used here which can be operated manually. The extraction tool 11 may be attached to the adapter 12 of the closing member 3 when the closing member 3 is to be removed from or fastened to the valve rod 6. Alternatively, naturally adapters 12 also may be arranged on the closing member 3 and configured such that the operating personnel grip these adapters 12 directly by hand. Such a variant is explained as an example below with reference to FIGS. 11 to 13.

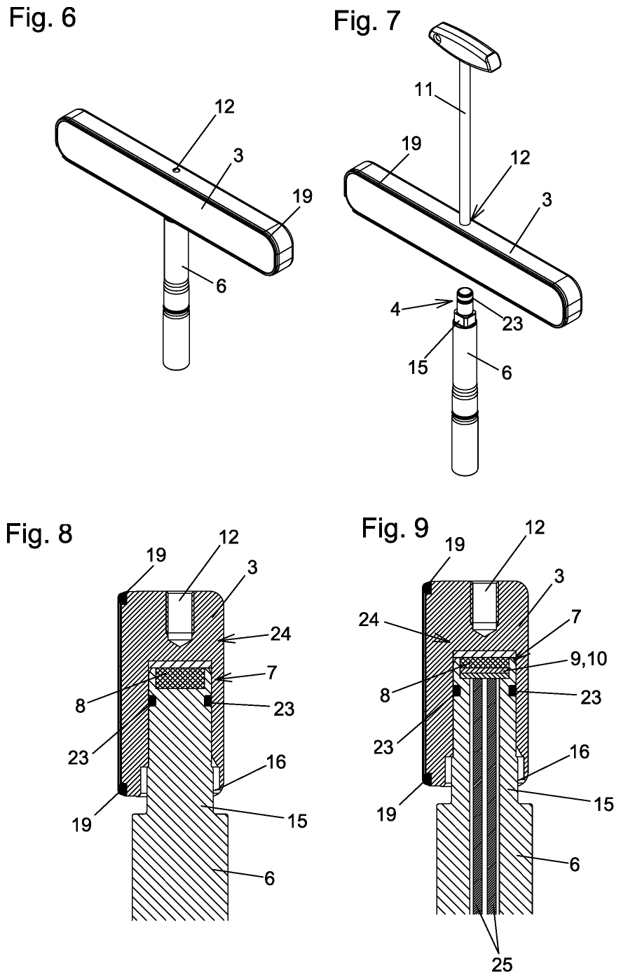

FIG. 6 shows only the valve rod 6 with closing member 3 fastened thereto. Here, the adapter 12 can be seen. As explained initially, it may be designed in widely varying ways so that a correspondingly configured extraction tool 11 may be fastened thereto. FIG. 7 shows the closing member 3 already removed from the valve rod 6 by means of the extraction tool 11. Part of the connecting device 7 according to the invention, with the seal 23 preferably arranged thereon, can be seen. FIG. 7 also shows a form-fit element 15 of the valve rod 6, which is here configured as a square with rounded corners. A complementary, correspondingly configured form-fit element 16 is formed on the closing member 3. As already explained initially, these form-fit elements 15 and 16 on the valve rod 6 and closing member 3 serve for orientation of the closing member 3 on the valve rod 6 when the closing member 3 is to be refastened to the valve rod 6. The cooperation of the form-fit elements 15 and 16, on fastening of the closing member 3 to the valve rod 6, ensures that the closing member 3 is fastened to the valve rod 6 in the desired position, and hence no special later adjustment or similar is required.

All the teaching outlined above should be regarded merely as exemplary. It may be implemented thus, but also in derived form in widely differing embodiment variants of a valve 1 according to the invention.

The configuration according to the invention of the releasable connecting device 7 of the first exemplary embodiment is explained with reference to FIG. 8.

FIG. 8 shows a longitudinal section through the upper end of the valve rod 6 and closing member 3 fastened thereto. The form-fit element 15 of the valve rod 6 extends a little into the closing member 3, so that it can cooperate with a corresponding form-fit element 16 on the closing member 3 for orientation of the closing member 3 on the valve rod 6. The seal 23 ensures a seal of the valve rod 6 against the closing member 3.

Independently of the concrete exemplary embodiment, in the invention it is thus favorably provided that the form-fit element on the valve rod extends a little into the closing member and cooperates with the form-fit element on the closing member for orientation of the closing member on the valve rod. In general, it is also favorable that a seal seals the valve rod against the closing member. It is preferably also provided that the fastening magnet is arranged on an upper end of the valve rod, and the seal is further away from the upper end of the valve rod than the fastening magnet. The latter is shown for example in FIGS. 8, 9, 10 and 14.

According to the invention, the releasable connecting device 7 shown in FIG. 8 comprises a fastening magnet 8 for removable fastening of the closing member 3 on the valve rod 6 by means of magnetic attraction forces. In FIG. 8, the fastening magnet 8 is a permanent magnet which is arranged in the valve rod 6 and cooperates with the closing member 3, which consists of a magnetizable material 24, e.g. iron or steel, or at least comprises such material. Naturally, by deviation from FIG. 8, it could also be provided that the fastening magnet 8 is situated in the closing member 3, and the valve 6 then comprises, at least at its upper end, a corresponding magnetizable material 24 or is made therefrom. In the fastened state shown in FIG. 8, the magnetic attraction forces of the fastening magnet 8 in any case hold the closing member 3 firmly on the valve rod 6. In this first exemplary embodiment, there is no mechanically or electrically driven release device 9. To remove the closing member 3 from the valve rod 6, accordingly a firm pull on the closing member 3 is required in order to overcome the magnetic attraction forces of the fastening magnet 8 and remove the closing member 3 from the valve rod 6, in the manner illustrated in FIG. 7.

A first variant, not explicitly illustrated here, for providing such a release device 9 would be to configure the fastening magnet 8 in FIG. 8 not as a permanent magnet but as an electromagnet. The magnetic attraction forces could then be eliminated by switching off the electromagnet. This variant however would have the disadvantage that the magnetic attraction forces required for fastening the closing member 3 to the valve rod 6 would only be available when the fastening magnet 8, configured as an electromagnet, is energized, which would constitute a corresponding permanent energy requirement.

FIG. 9 now shows an alternative embodiment in which again a permanent magnet is provided as the fastening magnet 8 in the valve rod 6. This variant according to FIG. 9 however comprises an electrically driven release device 9 for releasing the connection between the closing member 3 and the valve rod 6. This release device 9 comprises a counter-magnet 10 via which the magnetic attraction forces of the fastening magnet 8 can be weakened or completely eliminated. This counter-magnet 10 in FIG. 9 is configured as an electromagnet, as evident from the electric supply lines 25. When this counter-magnet 10, configured as an electromagnet, is activated, it weakens the magnetic attraction forces of the fastening magnet 8 at least so greatly that the closing member 3 can be removed from the valve rod 6 with only slight forces. When the counter-magnet 10, configured as an electromagnet, is however switched off, the magnetic attraction forces of the fastening magnet 8 are not influenced; because of the cooperation of the fastening magnet 8 with the magnetizable material 24 of the closing member 3 therefore, the magnetic attraction forces hold the closing member 3 on the valve rod 6. Apart from the differences explained above, the exemplary embodiment in FIG. 9 corresponds to the exemplary embodiment in FIG. 8.

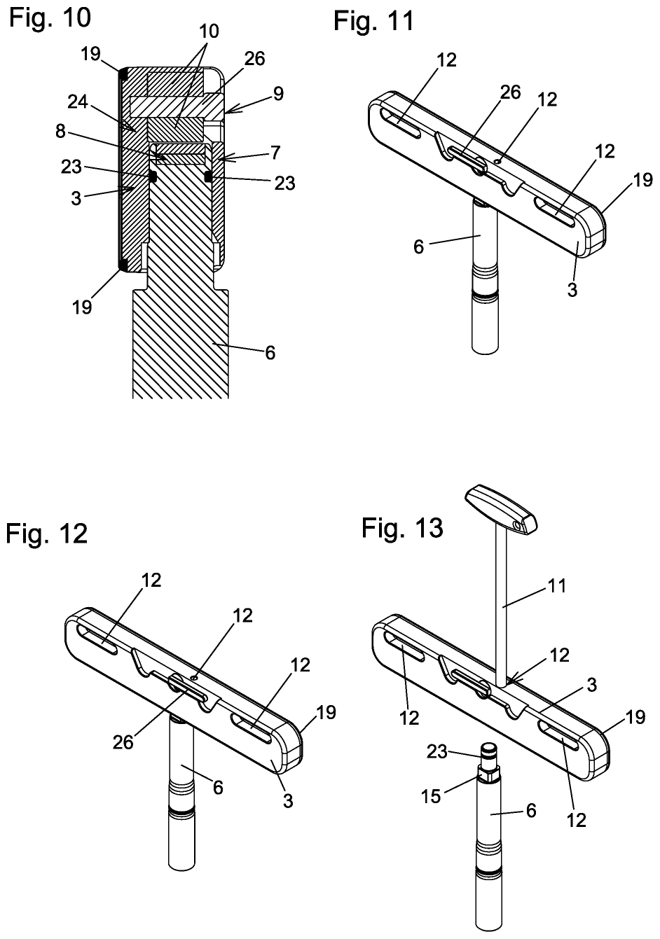

FIGS. 10 to 13 now show as an example a variant in which firstly a permanent magnet is arranged in the valve rod 6 as a fastening magnet 8. This also cooperates with the magnetizable material 24 of the closing member 3. In the exemplary embodiment according to FIGS. 10 to 13 however, by deviation from the variants shown in FIGS. 8 and 9, a mechanically driven release device 9 is provided for releasing the connection between the closing member 3 and the valve rod 6. This release device 9 too comprises a counter-magnet 10, via which the magnetic attraction forces of the fastening magnet 8 can be weakened or eliminated so far that the closing member 3 can be removed from the valve rod 6 with little force. Here, the counter-magnet 10 is a permanent magnet which is attached rotatably on a pivot lever 26. In the one position shown in FIGS. 10 and 12, the counter-magnet 10 is poled such that it does not weaken or even supports the magnetic attraction forces of the fastening magnet 8. In this position, the closing member 3 is thus fastened to the valve rod 6 by means of the magnetic attraction forces. If the pivot lever 26 and hence also the counter-magnet 10 are however pivoted into the position shown in FIGS. 11 and 13, the counter-magnet 10 is then poled such that it counters or weakens or eliminates the magnetic attraction forces of the fastening magnet 8, so that then—as shown in FIG. 13—the closing member 3 can be removed from the valve rod 6 relatively easily with little force. Naturally, in this exemplary embodiment, it would also be possible to arrange the fastening magnet 8 in the closing member 3. The valve rod 6 should then be made of correspondingly magnetizable material 24. The counter-magnet 10 with its pivot lever 26 could then be arranged both in the valve rod 6 and also in the closing member 3.

For the sake of completeness, it is pointed out that in all exemplary embodiments, the magnetizable material 24 could naturally also be replaced by corresponding further magnets, whereby even greater magnetic attraction forces would result.

With reference to FIGS. 11 to 13, it is additionally pointed out that here the closing member 3 comprises both an adapter 12 for an extraction tool 11 and also an adapter 12, here configured as a slot, for direct engagement in the closing member 3 by hand. These are merely examples and other variant embodiments are possible.

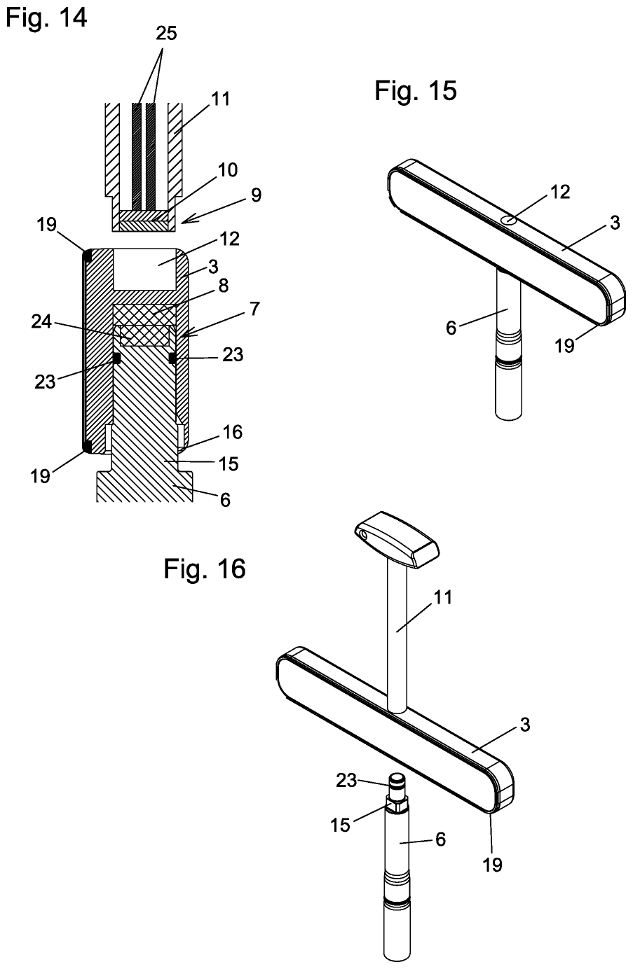

FIGS. 14 to 16 now show as an example a further variant according to the invention. Here, as a fastening magnet 8, a permanent magnet is provided in the closing member 3. This cooperates with the magnetizable material 24 in the valve rod 6 so that the magnetic attraction forces of the fastening magnet 8 hold the closing member 3 firmly on the valve rod 6. Naturally, the magnetizable material 24 could also be replaced by a corresponding further permanent magnet, whereby the magnetic attraction forces could be further increased. In this variant according to FIGS. 14 to 16, the release device 9 is now provided on the extraction tool 11. On the tip of the extraction tool 11, which is introduced into the adapter 12 of the closing member 3, is a counter-magnet 10 configured as an electromagnet which can be activated and deactivated via the electric supply lines 25. Accordingly, a power source such as e.g. an accumulator or a battery, and a corresponding switch for switching the counter-magnet 10 on and off, are integrated in the extraction tool 11, although not explicitly shown. When the counter-magnet 10 in the extraction tool 11 is activated, it can weaken or eliminate the magnetic attraction forces of the fastening magnet 8 so far that the closing member 3 can easily be removed from the valve rod 6. When the counter-magnet 10 is deactivated and/or the extraction tool 11 removed from the adapter 12, the closing member 3 is held firmly on the valve rod 6, in the position shown in FIG. 14, by means of the magnetic attraction forces.

FIG. 15 again shows the state in which the closing member 3 is fastened to the valve rod 6 and the extraction tool 11 has been withdrawn. FIG. 16 shows the state in which the closing member 3 has been removed from the valve rod 6 by means of the extraction tool 11, so that the form-fit element 16 (also provided here), and also the seal 23, can be seen on the valve rod 6.

### LIST OF REFERENCE SIGNS

1 Valve
2 Valve housing
3 Closing member
4 Valve opening
5 Valve drive
6 Valve rod
7 Connecting device
8 Fastening magnet
9 Release device
10 Counter-magnet
11 Extraction tool
12 Adapter
13 Side
14 Housing opening
Form-fit element
16 Form-fit element
17 First housing part
18 Second housing part
19 Seal
20 Housing cover
21 Screw
22 Seal
23 Seal
24 Magnetizable material
25 Electric supply line
26 Pivot lever
27 Vacuum passage
28 Movement track
29 Movement track

1. A valve, comprising:
a valve housing having a valve opening;
a closing member for closing the valve opening;
a valve drive that moves the closing member to and fro between a closed position, in which the closing member closes the valve opening, and an open position, in which the closing member fully or partially opens the valve opening;
the closing member is connected to the valve drive by a valve rod, and the closing member is removably fastened or fastenable to the valve rod by a releasable connecting device; and
the releasable connecting device has a fastening magnet for removably fastening the closing member to the valve rod via magnetic attraction forces.

2. The valve as claimed in claim 1, wherein at least one of: a) the fastening magnet is arranged on at least one of the valve rod or the closing member, b) the fastening magnet is a permanent magnet or an electromagnet, or c) a respective fastening magnet is provided on both the valve rod and on the closing member.

3. The valve as claimed in claim 1, further comprising a mechanically or electrically driven release device that is adapted to release the connection between the closing member and the valve rod.

4. The valve as claimed in claim 3, wherein the release device comprises a counter-magnet for weakening or eliminating the magnetic attraction forces of the fastening magnet.

5. The valve as claimed in claim 4, wherein the counter-magnet is arranged on at least one of the valve rod, the closing member, or a separate extraction tool.

6. The valve as claimed in claim 1, wherein the valve is an L-shaped valve.

7. The valve as claimed in claim 1, wherein the closing member has an adapter for at least one of manual removal of the closing member from the valve rod or manual fastening of the closing member to the valve rod.

8. The valve as claimed in claim 1, wherein on a side of the closing member facing away from the valve rod, the valve housing has a closable housing opening for extraction of the closing member from the valve housing.

9. The valve (1) as claimed in claim 1, wherein for orienting the closing member on the valve rod, respective form-fit elements are formed on the valve rod and on the closing member.

10. The valve as claimed in claim 9, wherein the form-fit element on the valve rod extends at least partly into the closing member and cooperates with the form-fit element on the closing member to orient the closing member on the valve rod.

11. The valve as claimed in claim 1, wherein the closing member is a valve disc.

12. The valve as claimed in claim 1, further comprising a seal that seals the valve rod against the closing member.

13. The valve as claimed in claim 12, wherein the fastening magnet is arranged on an upper end of the valve rod and the seal is further away from the upper end of the valve rod than the fastening magnet.

14. The valve as claimed in claim 4, wherein the counter-magnet is a permanent magnet or an electromagnet.

15. The valve as claimed in claim 1, wherein the valve opening has an opening cross-sectional area of at least 6000 mm2.
